(19) United States
(12) Patent Application Publication
(10) Pub. No.: US 2011/0227254 A1
(43) Pub. Date: Sep. 22, 2011

(54) BIOFOAM COMPOSITIONS FOR PRODUCTION OF BIODEGRADABLE OR COMPOSTABLE PRODUCTS

(75) Inventors: Monika Reck-Glenn, Durango, CO (US); Joe A. Bowden, Durango, CO (US)

(73) Assignee: New Ice Inc.

(21) Appl. No.: 13/049,102

(22) Filed: Mar. 16, 2011

Related U.S. Application Data
(60) Provisional application No. 61/314,891, filed on Mar. 17, 2010.

(51) Int. Cl. B29C 45/00; B29C 47/00; B29C 43/00

(52) U.S. Cl. 264/328.17; 264/330

(57) ABSTRACT

The present invention provides improved compositions and methods that can be utilized to produce biofoams. Biodegradable articles made from such biofoams are also described.

### PRIORITY CLAIM

This application claims priority to U.S. Provisional Patent Application No. 61/314,891, filed Mar. 17, 2010, the complete disclosure of which is hereby fully incorporated herein by reference.

### BACKGROUND OF THE INVENTION

Materials such as paper, paperboard, plastic, polystyrene, and even metals are presently used in enormous quantity in the manufacture of articles such as containers, separators, dividers, lids, tops, cans, and other packaging materials. Modern processing and packaging technology allows a wide range of liquid and solid goods to be stored, packaged, and shipped in packaging materials while being protected from harmful elements, such as gases, moisture, light, microorganisms, vermin, physical shock, crushing forces, vibration, leaking, or spilling. Many of these materials are characterized as being disposable, but actually have little, if any, functional biodegradability. For many of these products, the time for degradation in the environment can span decades or even centuries.

Each year, over 100 billion aluminum cans, billions of glass bottles, and thousands of tons of paper and plastic are used in storing and dispensing soft drinks, juices, processed foods, grains, beer and other products. In the United States alone, approximately 5.5 million tons of paper is consumed each year in packaging materials, which represents only about 15% of the total annual domestic paper production.

Packaging materials (e.g., paper, paperboard, plastic, polystyrene, glass, or metal) are all, to varying extents, damaging to the environment. For example, the manufacture of polystyrene products involves the use of a variety of hazardous chemicals and starting materials, such as benzene (a known mutagen and a probable carcinogen). Chlorofluorocarbons (or “CFCs”) have also been used in the manufacture of “blown” or “expanded” polystyrene products. CFCs have been linked to the destruction of the ozone layer.

Due to widespread environmental concerns, there has been significant pressure on companies to discontinue the use of polystyrene products in favor of more environmentally safe materials. Some groups have favored the use of products such as paper or other products made from wood pulp. However, there remain drawbacks to the sole use of paper due to the tremendous amount of energy that is required to produce it. A strong need to find new, easily degradable materials that meet necessary performance standards remains.

Degradability is a relative term. Some products which appear to be degraded merely break apart into very small pieces. These pieces are hard to see, but can still take decades or centuries to actually break down. Other products are made from materials which undergo a more rapid breakdown than non-biodegradable products. If the speed of this degradation is such that the product will degrade within a period of less than approximately 180 days under normal environmental conditions, the product is said to be compostable. Achievement of products made of compostable materials which also meet a variety of needs, such as containers for products in a damp or wet condition, has posed a significant challenge.

One solution has been to make packaging materials out of baked, edible sheets, e.g., waffles or pancakes made from a mixture of water, flour and a rising agent. Although edible sheets can be made into trays, cones, and cups which are easily decomposed, they pose a number of limitations. For example, since fats or oils are added to the mixture to permit removal of the sheet from the baking mold, oxidation of these fats cause the edible sheets to go rancid. In general, edible sheets are very brittle and far too fragile to replace most articles made from conventional materials. They are also overly sensitive to moisture and can easily mold or decompose prior to or during their intended use.

Starch is a plentiful, inexpensive and renewable material that is found in a large variety of plant sources, such as grains, tubers, and fruits. In many cases, starch is discarded as an unwanted byproduct of food processing. Starch is readily biodegradable and does not persist in the environment for a significant period after disposal. Starch is also a nutrient, which facilitates its breakdown and elimination from the environment.

Due to the biodegradable nature of starch, there have been many attempts to incorporate it into a variety of materials. Starch has been incorporated into multi-component compositions in various forms, including as filler and binder, and has been used as a constituent within thermoplastic polymer blends.

Starch can be used as a binder or glue to adhere solid constituents together to form a heterogeneous mixture of different components. At some point before or during the molding phase, the starch is typically dissolved or gelatinized in an appropriate solvent, such as water, so that the starch becomes a flowable material into which the other components can be dispersed. Since native starch has a melting point that approaches its decomposition temperature, it is necessary to add polar liquids or solvents to allow the starch to become molten, solvated or otherwise liquified into a plastic state at a temperature that is safely below its decomposition temperature. Upon resolidification of the gelatinized starch, typically by removing enough of the water by evaporation so that the starch recrystallizes or otherwise dries out, the starch forms a solid or semi-solid binding matrix that can bind the remaining components together. Although many have attempted for years to perfect a starch blend that would yield an environmentally sound material while, at the same time, being economical to make, such a combination has not yet been achieved.

There remains a need in the art to provide a fully compostable product that is strong, not prone to mold or pests, and can be readily and inexpensively made. Furthermore, there is a need to develop a robust method to develop compostable products that can be used to hold dry, wet or damp material at a range of temperatures.

U.S. Pat. No. 6,878,199 and U.S. Pat. No. 7,083,673 disclose methods and materials for forming biodegradable containers that can hold food products in dry, damp or wet conditions and provides the biodegradable containers prepared according to the disclosed process. The containers are produced through the use of a pre-gelled starch suspension that is said to be unique in its ability to form hydrated gels and to maintain this gel structure in the presence of many other types of materials and at low temperatures.

Although numerous attempts have been made to provide suitable biodegradable and compostable materials for packaging, the resulting substances are not ideal. The currently available materials either cannot successfully be used to package materials, particularly those that are wet, or do not effectively degrade under normal environmental conditions. A need exists to develop materials that will reduce the build up of disposed, slowly degrading materials, and to limit the environmental damage caused by toxic chemicals used in the production of packaging materials. Biodegradable or compostable materials of this sort, which are lightweight and flexible, are also highly desired.

### SUMMARY OF INVENTION

The present invention provides improved starch-based compositions that can be utilized to produce a biofoam, depending on the method of mixing the ingredients and the method of producing biodegradable articles, with improved properties.

The present invention provides improved starch-based biofoam compositions for forming biodegradable articles with improved properties.

In one aspect, the present invention comprises a biodegradable composition comprising a primary mixture and one or more additives. In one embodiment, the biodegradable composition is a biofoam. The primary mixture may comprise one or more starches, a source of fiber, powder, or pulp, one or more foaming agents, one or more mold release agents, bentonite clay, one or more thickening agents, and/or one or more types of diatomaceous earth. The primary mixture may also optionally include additives. The additives may comprise, but are not limited to, phospholipids, oils, citric acid, colorants, titanium dioxide, or any combination thereof. The one or more starches may include, but are not limited to, native starches, reclaimed starches, waxy starches, and/or modified starches

In one embodiment, the biofoam composition is made by rapidly pre-gelling a starch mixture, adding a diatomaceous earth mixture to form a combined mixture, mixing until the combined mixture is a homogeneous moldable mixture, and molding the homogeneous moldable mixture into a biofoam composition. In one embodiment, the rapid pre-gelling is of a starch-fiber mixture.

The diatomaceous earth may comprise 1-35% by weight of the biofoam composition. In another exemplary embodiment, the diatomaceous earth comprises 1-15% by weight of the biofoam composition. In yet another exemplary embodiment, the diatomaceous earth comprises 1-5% by weight of the biofoam composition. In another exemplary embodiment, the diatomaceous earth comprises 15-25% by weight of the biofoam composition. In another exemplary embodiment, the diatomaceous earth comprises 20-25% by weight of the biofoam composition. The diatomaceous earth may be native or processed or a combination of both types. The native diatomaceous earth may be fresh water, salt water or a combination of both types. In one exemplary embodiment, the diatomaceous earth is native fresh water derived diatomaceous earth. In another exemplary embodiment the diatomaceous earth is a flux calcined diatomaceous earth. In yet another exemplary embodiment the diatomaceous earth is processed by grinding and sieving into specific size ranges.

The biodegradable biofoam articles may be produced using injection molding, compression molding or extrusion molding methods.

The biofoam compositions of the present invention can be molded from rapidly pregelatinized starch mixtures using conventional injection molding equipment that utilizes pre-plasticization within the injection barrel. The pre-plasticized mixtures may then be used to form cups, cup lids, plates, small packaging materials or any disposable article typically made from conventional hydrocarbon-based plastics. In addition the biofoam compositions can be pelletized for future use.

In one exemplary embodiment, the one or more starches comprise 40-95% by weight of the biofoam composition. In another exemplary embodiment, the one or more starches comprise 45-75% by weight of the biofoam composition. In yet another exemplary embodiment, the one or more starches comprise 45-65% by weight of the biofoam composition. In another exemplary embodiment, the starches comprise 45-85% by weight of the biofoam composition.

The one or more starches may be one or more native or reclaimed starches, one or more waxy starches, one or more modified starch, or a combination of these starches. In one exemplary embodiment, the one or more starches is a native reclaimed starch selected from the group comprising corn starch, potato starch, tapioca starch, pea starch, or a combination of two or more of the starches. In another exemplary embodiment, the reclaimed native starch is a potato starch. In another exemplary embodiment, the one or more starches is a waxy starch selected from the group comprising waxy potato, waxy corn, and waxy tapioca starch. In yet another exemplary embodiment, the waxy starch is a waxy potato starch.

The one or more modified starch may be any suitable substituted modified starch, cross-linked starch, or a combination of both. In one exemplary embodiment, the modified starch is selected from the group comprising ester modified starches, either modified starches, succinylated starches, acetylated starches, oxidized starches, cross-linked starches, and/or phosphate derivative starches. In another exemplary embodiment, the modified starch is an acetylated starch. In yet another exemplary embodiment, the modified starch is a cross-linked starch. In another exemplary embodiment, the one or more modified starches are a combination of an acetylated starch and a cross-linked starch.

In one exemplary embodiment, the one or more modified starches comprise 1-45% by weight of the biofoam composition. In another exemplary embodiment, the one or more modified starches comprise 1-25% by weight of the biofoam composition. In yet another exemplary embodiment, the modified starches comprise 1-10% by weight of the biofoam composition. In another exemplary embodiment, the one or more modified starches comprise 1-5% by weight of the biofoam composition. In another exemplary embodiment, the one or more modified starches comprise 25-45% by weight of the biofoam composition. In yet another exemplary embodiment, the one or more modified starches comprise 35-45% by weight of the biofoam composition.

In one exemplary embodiment, one or more pre-gelatinized starches comprise 1-45% by weight of the biofoam composition. In another exemplary embodiment, the one or more pre-gelatinized starches comprise 1-25% by weight of the biofoam composition. In yet another exemplary embodiment, the modified starches comprise 1-10% by weight of the biofoam composition. Pre-gelatinized starch is a starch that has first been converted into a gelatinized state then dewatered and subsequently dried into a powder form.

The biofoam composition may comprise one or more types of fiber and/or one or more types of recycled, virgin or treated cellulosic pulps or powders. In another embodiment, the composition comprises recycled or virgin paper pulp. In yet another embodiment, the composition comprises wood fibers or wood flour. In another embodiment, the composition comprises recycled, virgin or treated cotton fibers. In one exemplary embodiment, the cellulosic pulps or powders comprise 1 to 25% by weight of the biofoam composition.

The biofoam composition may comprise one or more foaming agents. The foaming agent may be one of any known to one of skill in the art. In one embodiment, the foaming agent is CT 1480 (Clariant® Corp.).

Suitable mold release agents for use in the present invention include, but are not limited to, magnesium, calcium, or sodium stearate or oleates and similar lubricants including but not limited to lecithin, titanium dioxide and talc. In one embodiment, the mold release agent is present in an amount between about 1 and 15% by weight of the homogenous moldable composition.

Bentonite clay may comprise 1-30% by weight of the biofoam composition. In another exemplary embodiment, the bentonite clay may comprise 1-17% by weight of the biofoam composition. In yet another exemplary embodiment, the bentonite clay may comprise 1-5% by weight of the biofoam composition. In one exemplary embodiment the bentonite clay is sodium bentonite clay.

The biofoam composition may comprise one or more thickening agents. In another exemplary embodiment, the thickening agent comprises 1-5% by weight of the biofoam composition. In another exemplary embodiment, the thickening agent is xanthan gum.

One or more additives may be included in the biofoam composition based on the desired properties of the end use article to be manufactured from the biofoam compositions. The one or more additives may comprise, but is not limited to, phospholipids, oils, citric acid, colorants, titanium dioxide, or any combination thereof.

Phospholipids may be added to the primary mixture at a ratio of 12 to 25 grams per kilogram of primary mixture. In one exemplary embodiment, the source of phospholipids is lecithin. In another exemplary embodiment the source of lecithin is a renewable source such as soy beans.

Oils, such as canola, light mineral oil or soy bean oil may be added to the primary mixture at the ratio of 1 to 25 grams per kilogram of primary mixture.

Citric acid may be added to the primary mixture at a ratio of 1 to 10 grams per kilogram of primary mixture. If oil is added to the primary mixture, citric acid must be added to prevent rancidification of the oil. In one exemplary embodiment, the citric acid is anhydrous citric acid.

Colorants may be added to the primary mixture at a ratio of 1 to 75 grams per kilogram of primary mixture. Any suitable heat stable food grade colorant may be used in the present invention.

Titanium dioxide may be added to the primary mixture at a ratio of 1 to 50 grams per kilogram of primary mixture. Any suitable food grade source of titanium dioxide may be used in the present invention.

### DETAILED DESCRIPTION

The present invention provides improved starch-based biofoam compositions for forming biodegradable articles with improved properties.

In one aspect, the present invention comprises a biodegradable composition comprising a primary mixture and one or more additives. In one embodiment, the biodegradable composition is a biofoam. The primary mixture may comprise one or more starches, a source of fiber, powder, or pulp, one or more foaming agents, one or more mold release agents, bentonite clay, one or more thickening agents, and/or one or more types of diatomaceous earth. The primary mixture may also optionally include additives. The additives may comprise, but are not limited to, phospholipids, oils, citric acid, colorants, titanium dioxide, or any combination thereof. The one or more starches may include, but are not limited to, native starches, reclaimed starches, waxy starches, modified starches, and/or pre-gelatinized starches.

In one embodiment, the biofoam composition is made by rapidly pre-gelling a starch mixture (step 1), adding a diatomaceous earth mixture to form a combined mixture (step 2), mixing until the combined mixture is a homogeneous moldable mixture (step 3), and molding the homogeneous moldable mixture into a biofoam composition (step 4). Various other embodiments are also described herein, including those without starch in step 1, those with starch-fiber in step 1, and/or those without diatomaceous earth in step 2.

Native, Reclaimed and Waxy Starches

Starch is produced in many plants, and many sources of native and waxy starches may be in the compositions of the present invention (e.g., corn, waxy corn, wheat, sorghum, rice, and waxy rice, which can be used in the flour and cracked state). Other sources of starch useful in the present invention include tubers (potato), roots (tapioca, sweet potato, and arrowroot), and the pith of the sago palm. Suitable starches can also be selected from the following: ahipa, apio (arracacha), arrowhead (arrowroot, Chinese potato, jicama), baddo, bitter casava, Brazilian arrowroot, casava (yucca), Chinese artichoke (crosne), Japanese artichoke (chorogi), Chinese water chestnut, coco, cocoyam, dasheen, eddo, elephant's ear, girasole, goo, Japanese potato, Jerusalem artichoke (sunroot, girasole), lilly root, ling gaw, malanga (tanier), plantain, sweet potato, mandioca, manioc, Mexican potato, Mexican yam bean, old cocoyam, saa got, sato-imo, seegoo, sunchoke, sunroot, sweet casava, tanier, tannia, tannier, tapioca root, taro, topinambour, water chestnut, water lily root, yam bean, yam, yautia, barley, corn, sorghum, rice, wheat, oats, buckwheat, rye, kamut brand wheat, triticale, spelt, amaranth, black quinoa, hie, millet, plantago seed husks, psyllium seed husks, quinoa flakes, quinoa, teff and legumes such as the field pea.

“Waxy” starch is a term used to describe starches with high amylopectin ratios. In particular, the term “waxy” is often used to describe starch or flour containing at least about 85% by weight amylopectin, and more preferably, about 90% by weight amylopectin, and even more preferably, about 95% by weight amylopectin, and most preferably about 99% by weight amylopectin. Certain waxy starches are 100% amylopectin or, put another way, amylose-free.

“Native” or “non-waxy” starch is a term used to describe starches containing less than about 85% by weight amylopectin, and more preferably, lower than about 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, or 50% by weight amylopectin.

“Reclaimed” starch is any starch that is a by-product of a process that utilizes native starch or sources of native starch. An example of reclaimed potato starch is from the washing step in the production of French fries or potato chips prior to cooking These waste stream starches are processed to produce dry native reclaimed starch. The proportions of reclaimed starch are identical to those seen for native or non-waxy starches noted above.

The source of starch for the biofoam compositions according to the present invention may include starch mixtures of waxy and non-waxy (native or reclaimed) starches. In an exemplary embodiment, the starch mixture includes a first waxy starch and a second non-waxy (native) starch. For example, the starch mixture includes 100% amylopectin potato starch (amylose-free) and non-waxy potato starch (e.g., 80% amylopectin starch). Starch mixtures of waxy or non-waxy starches in proportions between about 0% and 99% can be used to form the biofoam compositions. In one embodiment, the waxy starch represents about 5, 10, 15, 20, 25, 30, 35, 40, 45, 50, 55, 60, 65, 70, 75, 80, 85, 90, 95, or 99% of the starch mixture.

In an exemplary embodiment, a potato starch mixture is used to form the primary mixture, which includes a high amylopectin content potato starch and a non-waxy potato starch, i.e., about 80% amylopectin. According to this embodiment, the starch mixture includes about 5, 10, 15, 20, 25, 30, 35, 40, 45, 50, 55, 60, 65, 70, 75, 80, 85, 90, 95, or 99% of the waxy potato starch. In one embodiment, the starch mixture is 50% waxy potato starch and 50% non-waxy potato starch.

The source of starch in the biofoam composition may also contain a mixture of starches from different botanical sources. For example, a starch mixture may include, but is not limited to, (i) native potato starch and native corn starch; or (ii) waxy potato starch and native tapioca starch, or (iii) native potato starch and native tapioca or corn starch. Starches suitable for combination include without limitation potato, tapioca, yam, cassava, corn, pea, rice, wheat and barley starch.

In one exemplary embodiment in the biofoam composition the starch is a mixture of native potato starch and native corn starch.

In another exemplary embodiment in the biofoam composition the starch is a mixture of native potato starch and native tapioca starch.

In another exemplary embodiment in the biofoam composition the starch is a mixture of native or reclaimed potato starch and native or reclaimed potato starch.

In one embodiment the starch component of the biofoam composition comprises 20%, 25%, 30%, 35%, 40%, 45%, 50%, 55%, 60%, 65%, 70%, 75%, 80%, 85%, 90%, or 95% by weight of the total biofoam composition.

Modified Starches

The biofoam compositions of the present invention may comprise one or more modified starches. A modified starch is a starch that can be derivatized or modified by typical processes known in the art, such as esterification, etherification, oxidation, acid hydolysis, cross-linking and enzyme conversion. Typical modified starches include esters, such as the acetate and the half esters of dicarboxylic acids/anhydrides, particularly the alkenylsuccinic acid/anhydrides; ethers, such as the hydroxyethyl and hydroxypropyl starches; acetylated starches; oxidized starches, such as those oxidized with hypochlorite; starches reacting with cross-linking agents, such as phosphorous oxychloride, epichlorohydrin, hydrophobic cationinc epoxides, and phosphate derivatives prepared by reaction with sodium or potassium orthophosphate or tripolyphospahate, and combinations thereof. Modified starches also include seagel, long chain alkylstarches, dextrins, amine starches, and dialdehyde starches.

The source of modified starches may comprise a mixture of one or more modified starches. In one exemplary embodiment, the modified starch component comprises an acetylated starch and a cross-linked starch. In one exemplary embodiment the cross-linked starch is a hydroxypropyl cross-linked starch.

In one embodiment, the modified starch component comprises 1% to 25% by weight of the biofoam composition. In another exemplary embodiment, the modified starch component comprises 1-20% by weight of the biofoam composition. In yet another exemplary embodiment, the modified starch component comprises 20% to 45% by weight of the biofoam composition.

Pre-Gelatinized Starches

Pre-gelatinized starch is a starch that has first been converted into a gelatinized state then dewatered and subsequently dried into a powder form. In one exemplary embodiment, one or more pre-gelatinized starches comprise 1-45% by weight of the biofoam composition. In another exemplary embodiment, the one or more pre-gelatinized starches comprise 1-25% by weight of the biofoam composition. In yet another exemplary embodiment, the modified starches comprise 1-10% by weight of the biofoam composition.

Fibers, Powders and/or Pulps

The primary mixture of the present invention may also contain one or more sources of fibers, powders, or pulps. This may include native and/or reclaimed cellulosic fibers, pulps, and/or powders.

The expression “fibers” refers to fine, thin objects restricted in their length, the length being greater than the width. They can be present as individual fibers or as fiber bundles. Such fibers can be produced in a manner known to those skilled in the art. Preferred fibers have a low length to diameter ratio and produce materials of excellent strength and light weight.

The fibers used are preferably organic, and most preferably cellulose-based materials, which are chemically similar to starches in that they comprise polymerized glucose molecules. “Cellulosic fibers” refers to fibers of any type which contain cellulose or consist of cellulose. Plant fibers preferred here are those of differing lengths typically in the range from 400 micron to 1000 micron, principally from hemp, cotton, plant leaves, sisal, abaca, bagasse, wood (both hard wood or soft wood, examples of which include southern hardwood and southern pine, respectively), or stems.

Alternatively, the fibers used may be inorganic fibers made from, but not limited to, glass, graphite, silica or ceramic materials.

Sources of flours suitable for use in the present invention preferably include wood flours. Wood flour and fibers are very much like rough tooth picks that have small barb-like structures coming out from the main fiber to participate in the cross linkage process with the cooling starch melt. The rapid grinding process to produce flour or short fibers by-passes the expensive and polluting processes that are used to manufacture pulp and paper. Preferably, the wood flour is hardwood flour, which contains smaller amounts of resin. Wood flours can be graded based on the mesh size the flour. In general, wood flour having a mesh size of 20-100 is suitable.

Sources for pulps used in the present invention preferably include cellulose pulps. Cellulose pulps, including virgin cellulose pulp and recycled cellulose pulp, can be derived from any of the wood or plant fibers described herein. Virgin cellulose pulp can be provided, e.g., as large blocks of compressed pulp and is derived from managed forests. Alternatively, virgin cellulose pulp can be obtained as loose pulps. Representative, non-limiting examples of cellulose pulps or powders include, e.g., Arbocel® 1000, IFC W260, IFC1178, Creafill TC 750 or similar cellulose products. Wood represents one source of cellulose pulp. Other suitable sources of cellulose pulp are known and include, e.g., cotton, flax, and hemp.

Cellulose (paper) pulp production is a process that utilizes mainly arboreal species from specialized cultivations. To produce the paper pulp, wood, typically reduced to dimensions of about 30-40 mm and a thickness of about 5-7 mm, is treated at high temperature and pressure with suitable mixes of chemical reagents that selectively attack lignin and hemicellulose macromolecules, rendering them soluble. Pulps coming from this first treatment, commonly called “cooking”, are called “raw pulps”; they still contain partly modified lignin and are more or less Havana-brown colored. Raw pulps can be submitted to further chemical-physical treatments suitable to eliminate almost entire lignin molecules and colored molecules in general; this second operation is commonly referred to as “bleaching”. For this process, rapid growth ligneous plants are mainly used, which, with the help of chemical substances (alkali or acids), in condition of high pressure and temperature, are selectively delignified to obtain pulps containing cellulose and other components of lignocellulose. These pulps are then submitted to mechanical and chemical-physical treatments, in order to complete the removal of lignin and hemicellulose residual components, and utilized thereafter for paper production. Any form of paper pulp can be used in the packaging materials described herein, including, but not limited to, Mercerized® pulps and fibers. In one exemplary embodiment, the source of cellulose fibers is recycled paper.

Diatomaceous Earth

Diatomaceous earth (or “DE”) can be used to replace substantial amounts of one or more starches in the biofoam mixture. The diatomaceous earth may be native or processed or a combination of both types. The native diatomaceous earth may be fresh water, salt water or a combination of both types. In one exemplary embodiment, the diatomaceous earth is native fresh water derived diatomaceous earth. In another exemplary embodiment the diatomaceous earth is a flux calcined diatomaceous earth. In yet another exemplary embodiment the diatomaceous earth is processed by grinding and sieving into specific size ranges. The diatomaceous earth may comprise 1-35% by weight of the biofoam composition. In another exemplary embodiment, the diatomaceous earth comprises 1-15% by weight of the biofoam composition. In yet another exemplary embodiment, the diatomaceous earth comprises 1-5% by weight of the biofoam composition. In another exemplary embodiment, the diatomaceous earth comprises 15-25% by weight of the biofoam composition. In another exemplary embodiment, the diatomaceous earth comprises 20-25% by weight of the biofoam composition.

Diatomaceous earth, unlike conventional fillers such as gypsum, calcium carbonate and clays such as kaolin, has a very high surface area per gram. This is often five or more times greater than typical fillers due to the voids or pores in diatomaceous earth. The positive effect of diatomaceous earth is increased when flux calcined at high temperatures. This treatment renders the surface charge of the diatomaceous earth slightly positive which will attract the slightly negative charge of the oxygen molecules found in starch and cellulose. This attraction between diatomaceous earth and the starch and cellulose produces a weak “cross-linkage or bridging”. This effect significantly increases the tensile strength and flexibility of products produced from mixtures of this type. Another aspect of the flux-calcined treatment is to render the diatomaceous earth white, an aspect favorable in the manufacture of biodegradable items.

The replacement of starch with diatomaceous earth results in unexpected improvements in the properties of the products made from the homogenous moldable compositions, such as, but not limited to, increases in flexibility and strength. In one embodiment, diatomaceous earth is used to replace at least 50%, at least 75%, or 100% of one or more starches of the homogenous mixture. In one exemplary embodiment, the diatomaceous earth is ground, washed, dried and passed through a #40 sieve. Powders passing smaller sieves (#80 to #200) may also be used. In one non-limiting embodiment, the diatomaceous earth will pass a #100 sieve and be retained on a #200 sieve. In one embodiment, the size of the diatomaceous earth is between 10 and 75 microns. In another embodiment the size of the diatomaceous earth is between 30 and 60 microns. In yet another embodiment, the diatomaceous earth is between 40 and 50 microns. In one embodiment, the diameter of the processed diatomaceous earth particles are such that the Darcy Permeability is between 1.5 and 5.0 darcy units. In another embodiment, the diatomaceous earth is produced from deposits of fresh water diatoms. In yet another embodiment, the diatomaceous earth is a fluxed calcined diatomaceous earth. A non-limiting example of fluxed calcined diatomaceous earth is CELITE® (World Minerals, Santa Barbara, Calif.). In yet another non-limiting example the mean pore size of the diatomaceous earth is 1 to 3 microns. In one embodiment the amount of diatomaceous earth used is in the range of 1-25% by weight of the homogenous moldable composition. In another embodiment, the amount of diatomaceous earth used is in the range of 5-25% by weight of the homogenous moldable composition. In yet another embodiment, the amount of diatomaceous earth used is 5-20% by weight of the biofoam composition.

### EXAMPLES OF IMPROVED PROPERTIES USING DIATOMACEOUS EARTH

Products of consistent weight are produced from mixtures both with and without diatomaceous earth and were tested using an Admet™ Universal Testing module fitted with an eP digital controller. Items tested on this unit produced numeric data that could be compared to determine differences in Peak Load, Peak Stress and Displacement in items made with and without diatomaceous earth.

Test one: In this test an undamaged tray is set up so that the force of the Admet™ system will break a tray along a solid edge placed at ⅔ of the longest axis of the tray to be tested. The unit offloads increasing amount of stress to the tray until it breaks. The Admet™ unit then calculates the peak load (in pounds), the peak stress applied at failure (in pounds per square inch (psi)) and the amount of flex or downward displacement at the time of failure (in inches displaced or flexed).

TABLE 1
Data from four formulas, three with different forms of diatomaceous earth added and
one without diatomaceous earth added.
Admet ™ Test # 1: Load, stress and flex

| | | | Displacement at |
|---|---|---|---|
| Test Mixture (refer to Examples) | Peak Load (lb) | Peak Stress (psi) | Break/(inches of flex) |
| Mixture BB: Fiber, Potato, | 4.26 | 12.6 | 0.6107 |
| Tapioca & Corn Starch | | | |
| Mixture BB-1: Fiber, Potato, | 5.25 | 15.6 | 0.7164 |
| Tapioca Starch and DICALITE ® | (23% increase) | (24% increase) | (17% increase) |
| Speedex brand calcined | | | |
| Diatomaceous earth*. | | | |
| Mixture BB-2: Fiber, Potato, | 8.03 | 24.0 | 0.9765 |
| Tapioca Starch and PERMA- | (88% increase) | (90% increase) | (60% increase) |
| GUARD ™ brand native | | | |
| Diatomaceous earth* | | | |
| Mixture BB-3: Fiber, Potato, | 7.06 | 21.0 | 1.104 |
| Tapioca Starch and CELITE ® | (66% increase) | (66% increase) | (81% increase) |
| 545 flux calcined Diatomaceous | | | |
| earth* | | | |

*Diatomaceous earth replaced the corn starch in this mixture

Test two: In this test an undamaged tray is set upside down on the test platform such that the downward force of the test piston will penetrate the tray thereby punching a hole through the tray bottom. As in Test One the unit offloads increasing amount of stress to the tray until the piston breaks through the tray. The Admet™ unit then calculates the peak load [in pounds], the peak stress applied at failure (in pounds per square inch (psi)) and the amount of flex or downward displacement at the time of failure (in inches displaced or flexed).

TABLE 2
Data from four formulas, three with different forms of diatomaceous earth added and
one without diatomaceous earth added.
Admet ™ Test # 2: Penetration Strength Test

| | | Peak Stress | Displacement At Break |
|---|---|---|---|
| Test Mixture (refer to Examples) | Peak Load (lb) | (psi) | (inches of flex) |
| Mixture BB: Fiber, Potato, | 12.4 | 37.0 | 0.5418 |
| Tapioca & Corn Starch | | | |
| Mixture BB-1: Fiber, Potato, | 15.17 | 45.5 | 0.7278 |
| Tapioca Starch & DICALITE ® | (22% increase) | (23% increase) | (34% increase) |
| Speedex brand flux calcined | | | |
| Diatomaceous earth*. | | | |
| Mixture BB-2: Fiber, Potato, | 16.05 | 48.3 | 0.7237 |
| Tapioca Starch and PERMA- | (29% increase) | (30% increase) | (34% increase) |
| GUARD ™ brand native | | | |
| Diatomaceous earth* | | | |
| Mixture BB-3: Fiber, Potato, | 19.66 | 59.0 | 0.8224 |
| Tapioca Starch and CELITE ® 545 | (58% increase) | (59% increase) | (52% increase) |
| flux calcined Diatomaceous earth* | | | |

*Diatomaceous earth replaced the corn starch in this mixture.

The data noted in Table 1 and 2 indicates when corn starch is replaced with diatomaceous earth a significant increase in load, stress and flex parameters is produced. This increase is also seen with different forms of diatomaceous earth. The same range of improvement is also seen when diatomaceous earth is used in mixtures that contain potato and/or corn starches. This positive enhancement indicates the diatomaceous earth effect is seen with a wide variety of starches, either singly or as mixtures.

The unique three dimensional structure of calcined diatomaceous earth produces a matrix of very numerous and very small channels through the homogeneous mixture. This three-dimensional matrix of nano tubules allows steam to egress from the curing material. As the material cures and the starch begins to crystallize, the normal channels for steam to escape would become closed and excessive pressure would destroy the biofoam yielding incomplete molded items. The presence of these nano tubules/three-dimensional spaces form numerous escape routes for high-pressure steam to exit during the curing process thereby preserving the closed-cell (biofoam) structure and allowing a complete item to be molded by any one of several molding techniques known to those skilled in the art. However the diatomaceous earth can be milled to smaller and smaller particles until the effective size of these nano tubules become so small as to be non-existent. Even when milled to a mean diameter of 10 microns the fresh water derived diatomaceous earth still retains its cylindrical shape and retains a mean pore diameter of 1.2 microns, ample space for high pressure steam to transverse. In the examples contained herein the diatomaceous earth was not milled below a 10 microns mean diameter. Another aspect of the addition of diatomaceous earth to the mixture is to produce a tray that has increased tolerance to elevated temperatures. Items can be made from mixtures, containing diatomaceous earth, that are ovenable, that is an item can withstand oven temperatures up to 350 deg F. Thereby allowing food to be heated in an conventional household oven.

Foaming Agents

The biofoam composition may comprise one or more foaming agents. The foaming agent may be one of any known to one of skill in the art. In one embodiment, the foaming agent is CT 1480 (Clariant® Corp.).

Mold Release Agents/Lubricants

Suitable mold release agents/lubricants include, but are not limited to, magnesium stearate, calcium stearate, or sodium stearate, or oleates and similar lubricants such as lecithin, talc and titanium dioxide. In one exemplary embodiment, the mold release agent is magnesium stearate. In yet another exemplary embodiment, the mold release agent is calcium stearate.

Bentonite Clay

Bentonite clay can be used to replace the pre-gelling starch as the medium to suspend the fiber and other additives during the mixing process. The replacement of pre-gel starch with bentonite clay gels gave unexpected results and provided a stable gel for mixing the other components into a dough-like consistency. The bentonite gel performed as well as the typical pre-gelling starch and produced a homogenous moldable composition. In one embodiment, bentonite clay is used to replace at least 50%, at least 75%, or 100% of the pre-gel starches of the homogenous mixture. In one exemplary embodiment, the bentonite is ground, and passed through a #60 sieve. Bentonite powders passing smaller sieves (#80 to #200) may also be used. In one non-limiting embodiment, the bentonite clay will pass a #100 sieve and be retained on a #200 sieve or passing the # 200 and retained on the #400 sieve. In another embodiment the bentonite powder will pass the #400 sieve. In one exemplary embodiment, the bentonite clay is ground sodium bentonite clay passing the #400 sieve. In one embodiment the amount of bentonite clay is in the range of 1-30% by weight of the homogenous moldable composition. In another embodiment, the amount of bentonite clay used is in the range of 1-17% by weight of the homogenous moldable composition. In yet another embodiment, the amount of bentonite clay used is 1-10% by weight of the biofoam composition.

Thickening Agents

The primary mixture may also optionally contain one or more thickening agents. Suitable thickening agents include cellulose-based thickening agents, which can include a wide variety of cellulosic ethers, such as methylhydroxyethylcellulose, hydroxymethylethylcellulose, carboxymethylcellulose, methylcellulose, ethylcellulose, hydroxyethylcellulose, hydroxyethylpropylcellulose, hydroxypropylmethylcellulose, and the like. Other natural polysaccharide-based thickening agents include, for example, alginic acid, phycocolloids, agar, xanthum gum, gum arabic, guar gum, locust bean gum, gum karaya, xanthan gum, and gum tragacanth. Suitable protein-based thickening agents include, for example, Zein® (a prolamine derived from corn), collagen (derivatives extracted from animal connective tissue such as gelatin and glue), and casein (derived from cow's milk). Suitable synthetic organic thickening agents include, for example, polyvinyl pyrrolidone, polyethylene glycol, polyvinyl alcohol, polyvinylmethyl ether, polyacrylic acids, polyacrylic acid salts, polyvinyl acrylic acids, polyvinyl acrylic acid salts, polyacrylamides, ethylene oxide polymers, polylactic acid, and latex. Latex is a broad category that includes a variety of polymerizable substances formed in a water emulsion. An example is styrene-butadiene copolymer. Additional copolymers include: vinyl acetate, acrylate copolymers, butadiene copolymers with styrene and acetonitrile, methylacrylates, vinyl chloride, acrylamide and fluorinated ethylenes. Hydrophilic monomers can be selected from the following group: N-(2-hydroxypropyl)methacrylamide, N-isopropyl acrylamide, N,N-diethylacryl-amide, N-ethylmethacrylamide, 2-hydroxyethyl methacrylate, acrylic acid 2-(2-hydroxyethoxy)ethyl methacrylate, methacrylic acid, and others, and can be used for the preparation of hydrolytically degradable polymeric gels. Suitable hydrophobic monomers can be selected from the 2-acetoxyethyl methacrylate group of monomers comprising dimethylaminoethyl methacrylate, n-butyl methacrylate, tert-butylacrylamide, n-butyl acrylate, methyl methacrylate, and hexyl acrylate.

Additives

In addition to the components of the primary mixture, the compositions of the present invention may further comprise, but are not limited to, one or more additives. The additives may comprise phospholipids, oils, citric acid, colorants, titanium dioxide, or any combination thereof.

Citric Acid

Citric Acid may comprise any food safe citric acid. One embodiment of citric acid is anhydrous citric acid.

Phospholipids

Suitable phospholipids for use in the present invention include, but are not limited to, phosphoglycerides such as phophatidylcholine (lecithin), phosphatidylethanolamine, phosphatidylserine, phosphotidyinositol, and phosphatidylglycerol. In one exemplary embodiment, the phospholipid is a lecithin. In another exemplary embodiment, the lecithin is a di-C18 lecithin.

Colorants

Suitable types of colorants that may be used in the present invention include any food grade source of heat stable colorant. Additional amounts of titanium dioxide may be added with the colorant to provide a uniform opacity and hue.

Oils

Suitable sources of oil that may be used in the present invention include, but are not limited to, canola oil, light mineral oil, sunflower oil and soy oil.

Titanium Dioxide

Suitable types of titanium dioxide that may be used in the present invention include any food grade source of titanium dioxide. Titanium dioxide may be added to the primary mixture as a colorant to provide a uniform opacity. Titanium dioxide may also function as a dry lubricant at the end of the extrusion process.

Preparation of Biofoam Compositions and Biodegradable Articles

In the processes/examples contained herein the terms “Rapid Gel Method” or “Rapid Gel” is used to describe the rapid pre-gelling of starch-fiber mixtures. “Rapid Gel Method” or “Rapid Gel” means a process whereby fiber is first added to water (in a 1:5 ratio, or a 1:4.5 ratio, or a 1:5.5 ratio, or similar ratio such that the fiber is well distributed and can be easily mixed) at temperatures that, when the gelling starch is then added, facilitate the rapid and near complete rupture of starch granules into a hydrocolloid. When the fiber is well dispersed, the starch is added. The Rapid Gel Method may take 30 minutes or longer, but in some cases, this time may be reduced. The rupture process is facilitated by mixing at higher shear values. Higher shear values reduce the time and temperature required to rupture 85 to 95% of the starch granules. Higher percentages of amylose in any specific starch granule will require higher shear, longer mixing time or higher temperature for rupture. In the processes and examples contained herein, the time of mixing can be reduced by higher temperatures (not above 90 deg C.) and/or by higher shear values. In the typical batch processes, the time required for rupture is long. In the typical twin-screw extruder/mixer process, the shear can be increased greatly. In these cases, the use of the extruder process reduces the time of mixing by ten fold or more. For example, a typical batch process requires 30 or more minutes at temperatures in the high 70's or low 80's (deg C.), whereas the twin screw process can achieve the same degree of rupture in one to three minutes and at a lower temperature. The degree to which starch granules rupture into a hydrocolloid is verifiable by high resolution light microscopy equipped with a video camera and high resolution monitor.

Batch Process: One or more of starch, cellulose and/or diatomaceous earth mixtures with any included additives, is/are added to the rapidly pre-gelled starch-fiber mixture (pre-gelled starch-fiber mixture made using Rapid Gel Method) to form a combined mixture. The process continues with mixing in a KITCHEN AID® Commercial Mixer for small test batches (1 to 3 L); or, for large test batches (100 to 140 L), a HOBART® Commercial Mixer for production. In either case the mixing is continued until the mixture becomes a homogeneous moldable mixture.

Continuous Process: One or more of starch, cellulose, and/or diatomaceous earth mixtures, with any included additives, is/are added to various zones of the continuous processor, such as the Twin Screw Continuous Processor (Readco Kurimoto®, LLC), to form a combined mixture. The continuous process will produce more consistent mixtures than the classic batch method. In addition these mixtures can be made more rapidly and drier than classic batch mixing process. These drier mixtures have a unique advantage when molded in injection molding systems. The continuous process still employs the Rapid Gel Method by pre-gelling the starch-fiber mixture in the first zones of the continuous processor prior to the addition of the other ingredients in later zones. In one embodiment, the commercial grade Twin Screw 2″ Continuous Processor (Readco Kurimoto®, LLC) is employed for production rates of 100 to 125 pounds per hour. In a second embodiment, the Twin Screw 5″ Continuous Processor (Readco Kurimoto®, LLC) is employed for higher rates of production. In either case the mixing is continued until the mixture becomes a homogeneous moldable mixture.

The homogeneous moldable mixture can now be molded into a biofoam composition via any one or more methods known to one of skill in the art including, but not limited to, injection molding, compression molding, extrusion methods, and/or thermoforming to produce cups, cup lids, plates, small packaging materials or any disposable article typically made from conventional hydrocarbon-based plastics. In addition the biofoam compositions may be pelletized for future use.

Injection molding of green (wet) biofoam mixtures is a multi-step process by which a green (wet) composition of the present invention is transferred from a packer into the heated barrel where the screw then forces it into a closed mold where it is shaped, and finally dried by additional heating until the moisture content is such that the item can be de-molded. The biofoam compositions are processed at higher or lower temperatures and/or pressures depending on water content of the green (wet) biofoam mixture.

Three common types of machines that are used in injection molding are a_ramming system, screw plasticator with injection, and reciprocating screw devices (Encyclopedia of Polymer Science and Engineering, Vol. 8, pp 102-138, John Wiley and Sons, New York 1987). A ram injection molding machine is composed of a cylinder, spreader, and plunger. The plunger forces the material into the mold. A screw plasticator with a second stage injection consists of a plasticator, directional valve, a cylinder without a spreader, and a ram. After plastication by the screw, the ram forces the material into the mold. A reciprocating screw injection machine is composed of a barrel and a screw. The screw rotates to mix the material and then moves forward to force the material into the mold.

An example of a suitable injection molding machine is an apparatus having a mold, a nozzle, and a barrel that is divided into zones wherein each zone is equipped with thermocouples and temperature-control units. The zones of the injection molding machine can be described as front, center, and rear zones whereby the biofoam mixtures are introduced into the front zone under controlled temperature. The temperature of the nozzle, mold, and barrel components of the injection molding machine can vary according to the processing temperature of the biofoam mixture and the molds used. Examples of other suitable injection molding machines include, but are not limited to, KraussMaffei® KM 110 750CX, Van Dorn® Model 150-RS-8F, Battenfeld® Model 1600, and Engel® Model ES80.

Compression molding consists of charging a quantity of a green [wet] biofoam composition of the present invention in the lower half of an open die. The top and bottom halves of the heated die are brought together under pressure, and then the biofoam composition conforms to the shape of the die and dries with the release of steam.

Extrusion molding consists of extruding the green [wet] biofoam mixture through a defined opening to produce a continuous strand, sheet or other three dimensional shape. These extruded items can then be cured, dried, allowed to expand or subjected to secondary treatment such as compression molding, cutting into specified lengths or other secondary procedure. Green (wet) biofoam material may be further formed through rollers to produce a thin sheet that can be thermoformed or otherwise cured.

Varying amounts of additional water are used to facilitate different types of molding, since the form of the pre-molded green (wet) product is dependent on the mold, heating rate and drying time. The material can also be rolled into green sheets and molded, extruded and made into damp or dry pellets for other processes. The means of production for the product could be created from any of several possible process approaches. Two specific methodologies are described below, but these descriptions are intended only to describe possible means of production, and shall not be construed in any way to represent a limitation to the outlined approach. While the compression molding process is useful, other types of compression molding, injection molding, extrusion, casting, pneumatic shaping, vacuum molding, etc can be used. One embodiment involves injection molding utilizing specialized high viscosity barrel loader technology.

In one embodiment, the homogeneous moldable mixture, prepared by either batch or continuous methods, is injection molded. In a non-limiting embodiment, the injection molding unit is a KraussMaffei® KM 110 750CX unit equipped with a standard all-purpose screw and fitted with a KraussMaffei® AZ 50 or AZ 100 specialized high viscosity material loader. In this embodiment the KM 110 750CX is set to operate with a pressure between 100 and 1000 kN clamp force, preferably between 130 and 500 kN. The temperature of the mold is set between 200° C. and 300° C., preferably between 220° C. and 250° C. The pre-injection barrel temperature is set between 25° C. and 95° C., preferably between 45° C. and 75° C. The cycle time is set between 20 and 120 seconds, preferably between 20 and 50 seconds. As the mixture is injected into the heated mold the starch-based binder gelates, increasing the viscosity of the mixture. Simultaneously, the mixture increases in volume within the heated mold cavity as a result of the formation of gas bubbles from the evaporating solvent, and/or foaming agents, which are initially trapped within the viscous matrix. By selectively controlling the thermodynamic parameters applied to the mixture (e.g., pressure, temperature, and time), as well as the viscosity and solvent content, the mixture can be formed into a form-stable article having a selectively designed cellular structural matrix. The inclusion of diatomaceous earth, in any non-limiting form, should be used when the injection molding process is used. When diatomaceous earth is omitted from the green (wet) mixture and injected into a hot mold, production problems may occur, including, but not limited to, incomplete mold filling, longer cycle times and loss of a smooth finish. In addition, significantly higher clamp pressures may be required to contain the explosive steam release. When diatomaceous earth is contained in the green (wet) mixture, the steam will transverse from the interior of the curing unit to venting structures outside the clamped mold. This dissipation of steam pressure as it is produced precludes the use of excessive clamp force and extended cure times.

In another embodiment, the homogeneous moldable mixture, prepared by either batch or continuous methods, is positioned within a heated female mold. Thereafter, a heated male mold is mated with the heated female mold (classic compression molding). As the mixture is heated, the starch-based binder gelates, increasing the viscosity of the mixture. Simultaneously, the mixture increases in volume within the heated mold's cavity as a result of the formation of gas bubbles from the evaporating solvent, and/or foaming agents, which are initially trapped within the viscous matrix. By selectively controlling the thermodynamic parameters applied to the mixture (e.g., pressure, temperature, and time), as well as the viscosity and solvent content, the mixture can be formed into a form-stable article having a selectively designed cellular structural matrix.

In a non-limiting embodiment, a temperature between 190-250° C., preferably 200° C., is used for baking for a time period of 60-90 seconds, preferably 75 seconds. Temperatures can vary based on the article being manufactured; for example, 200° C. is preferred for the rapid production of thin-walled articles, such as cups. Thicker articles require a longer time to remove the solvent and are preferably heated at lower temperatures to reduce the propensity of burning the starch-based binder and fiber. Leaving the articles within the locked molds too long can also result in cracking or deformation of the articles and loss of intrinsic strength.

A variety of articles can be produced from the processes and compositions of the present invention. The terms “article” and “article of manufacture” as used herein are intended to include all goods that can be formed using the disclosed process.

Coating of Molded Article

Before, during or after the molding process, coatings can be applied to the surface of an article for any desired purpose, such as to make the article more waterproof, grease and food product proof, more flexible, or to give it a glossier surface. Coatings can be used to alter the surface characteristics including sealing and protecting the article made therefrom. Coatings can provide protection against moisture, acid/base, grease, and organic solvents. They can provide a smoother, glossier, or scuff-resistant surface, they can help reinforce the article and coatings can also provide reflective, electrically conductive or insulative properties.

Water resistance can be achieved through the use of a water-resistant layer applied on one or both sides of the product. There are many currently available coatings that can be used to coat this product. Some of these include, but are not limited to, food grade biodegradable shellac, biodegradable mixtures of shellac and other biodegradable materials, commercial water and/or solvent-based coatings used in the paper industry, decolorized Zein® [a biodegradable material isolated from corn], poly lactic acid [PLA], polyhydroxy alkanoates [PHA], bacterial cellulose, chitosan-based polymers and natural waxes and oils.

A waterproof coating is desirable for articles intended to be in contact with liquid. As the articles having a starch-based binder have a high affinity for water, the preferred coatings are non-aqueous and have a low polarity. Appropriate coatings include paraffin (synthetic wax); shellac; drying oils; reconstituted oils from triglycerides or fatty acids from the drying oils to form esters with various glycols (butylene gylcol, ethylene glycol), sorbitol, and trimethylol ethane or propane; natural fossil resins including copal (tropical tree resins, fossil and modern), damar, glycol ester of damar, and sandarac (a brittle, faintly aromatic translucent resin derived from the sandarac pine of Africa); rosins and rosin derivatives including rosin (gum rosin, tall oil rosin, and wood rosin), rosin esters formed by reaction with specific glycols or alcohols, rosin esters, and rosin salts (calcium resinate and zinc resinate); polyvinyl acetate, polyvinyl alcohol, cellulosic materials (carboxymethylcellulose, cellulose acetate, ethylhydroxyethylcellulose, etc.); waxes (paraffin type I, paraffin type II, bees, and synthetic spermaceti); polyamides; polylactic acid; polyhydroxybutyrate-hydroxyvalerate copolymer; soybean protein; other synthetic polymers including biodegradable polymers.

The articles of the present invention can be, in one embodiment, coated with a biodegradable or compostable film(s). In a non-limiting embodiment a heated film is applied to a heated biodegradable or compostable container, wherein the temperature of the container is approximately the melt temperature of the biodegradable film. The film can be applied by any one of many methods familiar to anyone proficient in the art.

Types of Articles Produced

Materials capable of holding dry, damp and wet products have diverse uses. Containers suitable for holding dry materials can be used to hold dried fruit, or raw nuts such as almonds. Containers suitable for holding damp materials can be used to hold fresh produce and should be able to perform this function for a period of at least about two to three weeks since normal packing to use time is about 14 days. Damp food packing can also be used with a hot fast food item such as French fries or hamburger, in which case the container needs to last for only a short time, for example one hour after addition of the damp food. Damp food packing could also be used, in combination with an adsorbent pad, to package raw meat. In this case, the container needs to withstand exposure to the meat for a period of seven days or longer and desirably can stand at least one cycle of freeze and thaw. If possible this package should be able to withstand a microwave signal. When formulated for holding wet foods, the containers of the invention will suitably have the ability to hold a hot liquid, such as a bowl of soup, a cup of coffee or other food item for a period of time sufficient to allow consumption before cooling, for example within one hour of purchase. Such containers can also be used to hold a dry product that will be re-hydrated with hot water such as the soup-in-a-cup products. Containers can also be produced such that the contents can be frozen, stored and re-warmed by either microwave or household oven methods.

Articles made from the present invention can be manufactured into a wide variety of finished articles that can presently be made with plastics, paper, paperboard, polystyrene, metals, ceramics, and other materials. Merely by way of example, it is possible to manufacture the following exemplary articles: containers, including disposable and non-disposable food or beverage containers, sandwich containers, “clam shell” containers (including, but not limited to, hinged containers used with fast-food sandwiches such as hamburgers), golf tees, toys, building products, frozen food boxes, beverage carriers, cups, French fry containers, fast food carryout boxes, packaging materials such as spacing material, computer chip boards, support trays for supporting products (such as cookies and candy bars), a variety of cartons and boxes such as corrugated boxes, cigar boxes, confectionery boxes, and boxes for cosmetics, various eating utensils and storage containers such as dishes, lids, cutlery, knives, forks, spoons, cases, crates, trays, baking trays, bowls, microwaveable dinner trays, “TV” dinner trays, egg cartons, meat packaging platters, disposable plates, vending plates, pie plates, and breakfast plates, compartmentalized trays such as a “school tray”, and a variety of other objects.

The container should be capable of holding its contents, whether stationary or in movement or handling, while maintaining its structural integrity and that of the materials contained therein or thereon. This does not mean that the container is required to withstand strong or even minimal external forces. In fact, it can be desirable in some cases for a particular container to be extremely fragile or perishable. The container should, however, be capable of performing the function for which it was intended. The necessary properties can always be designed into the material, structure and production method of the container beforehand.

The container should also be capable of containing its goods and maintaining its integrity for a sufficient period of time to satisfy its intended use. It will be appreciated that, under certain circumstances, the container can seal the contents from the external environments, and in other circumstances can merely hold or retain the contents.

The terms “container” or “containers” as used herein, are intended to include any receptacle or vessel utilized for, e.g., packaging, storing, shipping, serving, portioning, or dispensing various types of products or objects (including both solids and liquids), whether such use is intended to be for a short-term or a long-term duration of time.

Containment products used in conjunction with the containers are also intended to be included within the term “containers.” Such products include, for example, lids, interior packaging such as partitions, liners, anchor pads, corner braces, corner protectors, clearance pads, trays, cushioning materials, and other objects used in packaging, storing, shipping, portioning, serving, or dispensing an object within a container.

The containers within the purview of the present invention can or can not be classified as being disposable. In some cases, where a stronger, more durable construction is required, the container might be capable of repeated use. On the other hand, the container might be manufactured in such a way so as to be economical for it to be used only once and then discarded. The present containers have a composition such that they can be readily composted, discarded or thrown away as conventional landfill waste. The present container is an environmentally neutral material. The present containers can be burned or biodigested in an energy capture facility without the production of harmful by-products.

The articles within the scope of the present invention can have greatly varying thicknesses depending on the particular application for which the article is intended. They can be as thin as about 1 mm for uses such as in a cup. In contrast, they can be as thick as needed where strength, durability, and/or bulk are important considerations. For example, the article can be up to about 2 cm thick or more to act as a specialized packing container or cooler. The preferred thickness for most articles is in a range from about 1.0 mm to about 5 mm with about 1 mm to about 2.5 mm preferred.

Using a microstructural engineering approach, the present invention can produce a variety of articles, including plates, cups, cartons, and other types of containers and articles having mechanical properties substantially similar or even superior to their counterparts made from conventional materials, such as paper, polystyrene foam, plastic, metal and glass. The inventive articles can also be made at a cost similar to their conventional counterparts. The reduced cost is a result of the relatively inexpensive diatomaceous earth which typically comprises a significant percentage of the mixture. This addition of diatomaceous earth as an active ingredient, rather than as a simple classic filler, allows the production of items with thinner wall thickness, thereby lowering the processing energy required.

The method of the present invention provides basic methodologies which can be utilized with little modification and a basic material from which product items can be produced by tailoring of the additives and additional processing steps employed. The composition preferably contains at least 75%, at least 85% or at least 95% or more of natural or organic-derived materials by weight of the homogenous moldable composition.

Certain modifications and improvements will occur to those skilled in the art upon a reading of the foregoing description. It should be understood that all such modifications and improvements have been deleted herein for the sake of conciseness and readability but are properly within the scope of the following claims.

### EXAMPLES

The following examples are presented in order to more specifically teach compositions and process conditions for forming the biofoam compositions according to the present invention, as well as articles formed from the biofoam compositions. The examples include various mix designs, as well as various processes for manufacturing biofoam compositions, including sheets, films, pellets, containers, and other articles of manufacture. In general, but not in all cases, the basic composition of biofoam mixtures in the examples below follow these guidelines:

| | |
|---|---|
| Part one | pre-gelling starch |
| | fiber |
| | water |
| Part two | starch |
| | diatomaceous earth |
| | other ingredients |

Part one is Rapid Gelled (using Rapid Gel Method) to form a pre-gel as described in each example. Once the pre-gel phase is complete, Part two ingredients are added to the pre-gel to form a combined mixture which is mixed until it is a homogeneous moldable mixture as described in each example.
   Examples are as follows:

### Example AA

### Tapioca Starch-Diatomaceous Earth, Oil Mix

1. Part 1, form a pre-gelled cellulose fiber-potato starch suspension using the Rapid Gel Method noted below:

51 g native potato starch 7.6%

65 g virgin cellulose pulp (fiber) 9.7%

4.75 g soy oil 0.7%

550 g water: 82%

To Rapid Gel, mix the cellulose-potato starch, fiber and oil in preheated 70-85 deg C. water, with a paddle blade in a KITCHEN AID® Commercial Mixer. The fiber is well dispersed into the starch gel (Rapid Gel Method) by mixing until the temperature drops below 62 deg C. This may take 30 or more minutes to complete. At this time, the mixture is a pre-gelled homogeneous suspension. Once gelled, the gel may be used hot, cooled or refrigerated, but not frozen.
2. Part 2, premix the following dry materials to form a homogenous mixture:

163 g native tapioca starch

55 g diatomaceous earth (CELITE® 545)

2.5 g magnesium stearate

0.37 g citric acid

0.5 g foaming agent
3. Slowly add the Part 2 homogenous dry mixture to the pre-gelled fiber-starch using low speed on the KITCHEN AID® Commercial Mixer until blended. Mix for ten additional min. to condition the dough mix. This mixture is stable and can be molded hot or stored by refrigeration, but not frozen.

### Example BB

### Tapioca-Corn Starch Without Diatomaceous Earth Mix

1. Part 1, form a pre-gelled cellulose fiber-potato starch suspension using the Rapid Gel Method noted below:

51 g native potato starch 8.1%

65 g virgin cellulose pulp (fiber): 10.4%

510 g water: 81.5%

To Rapid Gel the pre-gelled cellulose-potato starch (part 1), mix fiber into preheated water at 70-85 deg C. and mix with a paddle blade in a KITCHEN AID® Commercial Mixer. When the fiber is well dispersed, the starch is Rapid Gelled by mixing until the temperature drops below 62 deg C. This may take 30 or more minutes to complete. At this time, the mixture is a homogeneous pre-gel suspension. Once gelled, the gel may be used hot, cooled or refrigerated, but not frozen.
2. Part 2, premix the following dry materials to form a homogenous mixture:

163 g native tapioca starch

159 g native corn starch

2.5 g magnesium stearate

0.5 g foaming agent
3. Slowly add the Part 2 homogenous dry mixture to the pre-gelled fiber-starch using low speed on the KITCHEN AID® Commercial Mixer until blended and for ten additional min to condition the dough mix. This mixture is stable and can be molded hot or stored by refrigeration, but not frozen.

### Example BB-1

### Tapioca Starch-Diatomaceous Earth Mix

1. Part 1, form a pre-gelled cellulose fiber-potato starch suspension using the Rapid Gel Method noted below.

51 g native potato starch 8.1%

65 g virgin cellulose pulp (fiber): 10.4%

510 g water: 81.5%

To Rapid Gel the pre-gelled cellulose-potato starch (part 1), mix fiber into preheated water at 70-85 deg C. and mix with a paddle blade in a KITCHEN AID® Commercial Mixer. When the fiber is well dispersed, the starch is Rapid Gelled by mixing until the temperature drops below 62 deg C. This may take 30 or more minutes to complete. At this time, the mixture is a homogeneous pre-gel suspension. Once gelled, the gel may be used hot, cooled or refrigerated, but not frozen.
2. Part 2, premix the following dry materials to form a homogenous mixture:

163 g native tapioca starch

55 g diatomaceous earth (DICALITE® Speedex)

2.5 g magnesium stearate

0.5 g foaming agent
3. Slowly add the Part 2 homogenous dry mixture to the pre-gelled fiber-starch using low speed on the KITCHEN AID® Commercial Mixer until blended and for ten additional min. to condition the dough mix. This mixture is stable and can be molded hot or stored by refrigeration, but not frozen.

### Example BB-2

### Same as BB-1 Except that PERIVIA-GUARD™ Brand Native Diatomaceous Earth Replaced DICALITE® Speedex Flux Calcined Brand of Diatomaceous Earth

### Example BB-3

### Same as BB-1 Except that CELITE® 545 Brand Flux Calcined Brand Diatomaceous Earth Replaced DICALITE® Speedex Flux Calcined Brand of Diatomaceous Earth

### Example CC

### Tapioca Starch-Diatomaceous Earth with Oil Mix

1. Part 1, form a pre-gelled cellulose fiber-potato starch suspension using the Rapid Gel Method:

51 g native potato starch: 7.6%

65 g virgin cellulose pulp: 9.7%

4.75 g soy oil: 0.7%

550 g water: 82%

To Rapid Gel the pre-gelled cellulose-potato starch (part 1), mix fiber into preheated water at 70-85 deg C. and mix with a paddle blade in a KITCHEN AID® Commercial Mixer. When the fiber is well dispersed, the starch is Rapid Gelled by mixing until the temperature drops below 62 deg C. This may take 30 or more minutes to complete. At this time, the mixture is a homogeneous pre-gel suspension. Once gelled, the gel may be used hot, cooled or refrigerated, but not frozen.
2. Part 2, premix the following dry materials to form a homogenous mixture:

163 g native tapioca starch

55 g diatomaceous earth (CELITE® 545)

0.37 g citric acid

2.5 g magnesium stearate

0.5 g foaming agent
3. Slowly add the Part 2 homogenous dry mixture to the pre-gelled fiber-starch using low speed, on the KITCHEN AID® Commercial Mixer, until blended and for ten additional min. to condition the dough mix. This mixture is stable and can be molded hot or stored by refrigeration, but not frozen.

### Example DD

### Potato Starch-Diatomaceous Earth Oil Mix

1. Form a pre-gelled cellulose fiber-potato starch suspension using the Rapid Gel Method:

51 g native potato starch: 7.6%

65 g virgin cellulose pulp: 9.7%

4.75 g soy oil: 0.7%

550 g water: 82%

To Rapid Gel the pre-gelled cellulose-potato starch (part 1), mix fiber and oil into preheated water at 70-85 deg C. and mix with a paddle blade in a KITCHEN AID® Commercial Mixer. When the fiber is well dispersed, the starch is Rapid Gelled by mixing until the temperature drops below 62 deg C. This may take 30 or more minutes to complete. At this time, the mixture is a homogeneous pre-gel suspension. Once gelled, the gel may be used hot, cooled or refrigerated, but not frozen.
2. Part 2, premix the following dry materials to form a homogenous mixture:

178 g native potato starch

55 g diatomaceous earth (CELITE® 545)

0.37 g citric acid

2.5 g magnesium stearate

0.5 g foaming agent
3. Slowly add the Part 2 homogenous dry mixture to the pre-gelled fiber-starch using low speed, on the KITCHEN AID® Commercial Mixer, until blended and for ten additional min. to condition the dough mix. This mixture is stable and can be molded hot or stored by refrigeration, but not frozen.

### Example EE

### Tapioca Starch-Diatomaceous Earth Mix with Added Water Repellant

b 1. Form a pre-gelled cellulose fiber-waxy potato starch suspension using the Rapid Gel Method:

51 g native potato starch: 7.6%

65 g virgin cellulose pulp: 9.7%

4.75 g soy oil: 0.7%

550 g water: 82%

To Rapid Gel the pre-gelled cellulose-potato starch (part 1), mix fiber and oil into preheated water at 70-85 deg C. and mix with a paddle blade in a KITCHEN AID® Commercial Mixer. When the fiber is well dispersed, the starch is Rapid Gelled by mixing until the temperature drops below 62 deg C. This may take 30 or more minutes to complete. At this time, the mixture is a homogeneous pre-gel suspension. Once gelled, the gel may be used hot, cooled or refrigerated, but not frozen.
2. Part 2, premix the following dry materials to form a homogenous mixture:

163 g native tapioca starch

55 g diatomaceous earth (CELITE® 545)

10 g calcium stearate

0.37 g citric acid

2.5 g magnesium stearate

0.5 g foaming agent
3. Slowly add the Part 2 homogenous dry mixture to the pre-gelled fiber-starch using low speed on the KITCHEN AID® Commercial Mixer until blended and for ten additional min. to condition the dough mix. This mixture is stable and can be molded hot or stored by refrigeration, but not frozen.

### Example FF

### Higher Amount of Diatomaceous Earth-Tapioca Starch Mix

1. Form a pre-gelled cellulose fiber-waxy potato starch suspension using the Rapid Gel Method:

51 g native potato starch: 7.6%

65 g virgin cellulose pulp: 9.7%

4.75 g soy oil: 0.7%

550 g water: 82%

To Rapid Gel the pre-gelled cellulose-potato starch [part 1], mix fiber and oil into preheated water at 70-85 deg C. and mix with a paddle blade in a KITCHEN AID® Commercial Mixer. When the fiber is well dispersed, the starch is Rapid Gelled by mixing until the temperature drops below 62 deg C. This may take 30 or more minutes to complete. At this time, the mixture is a homogeneous pre-gel suspension. Once gelled, the gel may be used hot, cooled or refrigerated, but not frozen.
2. Part 2, premix the following dry materials to form a homogenous mixture:

85 g diatomaceous earth (CELITE® 545)

81.5 g native tapioca starch

0.37 g citric acid

2.5 g magnesium stearate

0.5 g foaming agent
3. Slowly add the Part 2 homogenous dry mixture to the pre-gelled fiber-starch using low speed on the KITCHEN AID® Commercial Mixer until blended and for ten additional min. to condition the dough mix. This mixture is stable and can be molded hot or stored by refrigeration, but not frozen.

### Example GG

### Pea Starch Gelling Diatomaceous Earth Oil Mix

1. Form a pre-gelled cellulose fiber-pea starch suspension using the Rapid Gel Method:

51 g native pea starch: 7.6%

65 g virgin cellulose pulp: 9.7%

4.75 g soy oil: 0.7%

550 g water: 82%

To Rapid Gel the pre-gelled cellulose-potato starch (part 1), mix fiber and oil into preheated water at 70-85 deg C. and mix with a paddle blade in a KITCHEN AID® Commercial Mixer. When the fiber is well dispersed, the starch is Rapid Gelled by mixing until the temperature drops below 62 deg C. This may take 30 or more minutes to complete. At this time, the mixture is a homogeneous pre-gel suspension. Once gelled, the gel may be used hot, cooled or refrigerated, but not frozen.
2. Part 2, premix the following dry materials to form a homogenous mixture:

85 g diatomaceous earth (CELITE® 545)

81.5 g native tapioca starch

0.37 g citric acid

2.5 g magnesium stearate

0.5 g foaming agent
3. Slowly add the Part 2 homogenous dry mixture to the pre-gelled fiber-starch using low speed on the KITCHEN AID® Commercial Mixer until blended and for ten additional min. to condition the dough mix. This mixture is stable and can be molded hot or stored by refrigeration, but not frozen.

### Example HH

### Large Batch Potato Starch Diatomaceous Earth Mix

1. Form a pre-gelled cellulose fiber-potato starch suspension using the Rapid Gel Method:

1.28 kg native potato starch

1.63 kg virgin cellulose pulp

7.5 kg water

To Rapid Gel the pre-gelled cellulose-potato starch (part 1), mix fiber into preheated water at 70-85 deg C. and mix with a paddle blade in a HOBART® Commercial Mixer. When the fiber is well dispersed, the starch is Rapid Gelled by mixing until the temperature drops below 62 deg C. This may take 30 or more minutes to complete. At this time, the mixture is a homogeneous pre-gel suspension. Once gelled, the gel may be used hot, cooled or refrigerated, but not frozen.
2. Part 2, premix the following dry materials to form a homogenous mixture:

1.83 kg diatomaceous earth (DICALITE® Speedex)

3.0 kg native potato starch

50 g titanium dioxide

150 g calcium stearate

20 g foaming agent
3. Slowly add the Part 2 homogenous dry mixture to the pre-gelled fiber-starch using low speed, on the HOBART® Commercial Mixer, until blended and for ten additional min. to condition the dough mix. This mixture is stable and can be molded hot or stored by refrigeration, but not frozen.

### Example II

### Large Batch Potato Starch Diatomaceous Earth Mix

1. Form a pre-gelled cellulose fiber-potato starch suspension using the Rapid Gel Method:

1.28 kg native potato starch

1.63 kg virgin cellulose pulp

5.0 kg water

To Rapid Gel the pre-gelled cellulose-potato starch (part 1), mix fiber into preheated water at 70-85 deg C. and mix with a paddle blade in a HOBART® Commercial Mixer. When the fiber is well dispersed, the starch is Rapid Gelled by mixing until the temperature drops below 62 deg C. This may take 30 or more minutes to complete. The higher the shear (speed of mixing) the less time needed for complete mixing and starch restructuring. At this time, the mixture is a homogeneous pre-gel suspension. Once gelled, the gel may be used hot, cooled or refrigerated, but not frozen.
2. Part 2, premix the following dry materials to form a homogenous mixture:

1.83 kg diatomaceous earth (DICALITE® Speedex)

3.0 kg native potato starch

50 g titanium dioxide

150 g calcium stearate

20 g foaming agent
3. Slowly add the Part 2 homogenous dry mixture to the pre-gelled fiber-starch using low speed on the HOBART® Commercial Mixer until blended; then increase the speed (shear) and mix for an additional 15-30 min. Additional mixing in an open bowl will produce a drier dough mixture with the total water reduced to 45%. This drier mixture has unique advantages when molded in an injection system. This mixture is stable and can be molded hot or stored by refrigeration, but not frozen.

### Example JJ

### Large Batch Corn Starch Diatomaceous Earth Mix

1. Form a pre-gelled cellulose fiber-potato starch suspension using the Rapid Gel Method:

1.45 kg native potato starch

1.63 kg virgin cellulose pulp

7.5 kg water

To Rapid Gel the pre-gelled cellulose-potato starch (part 1), mix fiber into preheated water at 70-85 deg C. and mix with a paddle blade in a HOBART® Commercial Mixer. When the fiber is well dispersed, the starch is Rapid Gelled by mixing until the temperature drops below 62 deg C. This may take 30 or more minutes to complete. At this time, the mixture is a homogeneous pre-gel suspension. Once gelled, the gel may be used hot, cooled or refrigerated (but not frozen) until used.
2. Part 2, premix the following dry materials to form a homogenous mixture:

1.37 kg diatomaceous earth (DICALITE® Speedex)

3.97 kg native corn starch

50 g titanium dioxide

150 g calcium stearate

20 g foaming agent
3. Slowly add the Part 2 homogenous dry mixture to the pre-gelled fiber-starch using low speed on the HOBART® Commercial Mixer until blended and for ten additional min. to condition the dough mix. This mixture is stable and can be molded hot or stored by refrigeration, but not frozen.

### Example KK

### Large Batch Reclaimed Potato Starch Diatomaceous Earth Mix

1. Form a pre-gelled cellulose fiber-potato starch suspension using the Rapid Gel Method;

1.45 kg reclaimed potato starch

1.63 kg virgin cellulose pulp

8.0 kg water

To Rapid Gel the pre-gelled cellulose-potato starch (part 1), mix fiber into preheated water at 70-85 deg C. and mix with a paddle blade in a HOBART® Commercial Mixer. When the fiber is well dispersed, the starch is Rapid Gelled by mixing until the temperature drops below 62 deg C. This may take 30 or more minutes to complete. At this time, the mixture is a homogeneous pre-gel suspension. Once gelled, the gel may be used hot, cooled or refrigerated, but not frozen.
2. Part 2, premix the following dry materials to form a homogenous mixture;

1.83 kg diatomaceous earth (DICALITE® Speedex)

3.0 kg reclaimed potato starch

50 g titanium dioxide

150 g calcium stearate

20 g foaming agent
3. Slowly add the Part 2 homogenous dry mixture to the pre-gelled fiber-starch using low speed on the HOBART® Commercial Mixer until blended and for 10 to 30 additional min. to condition the dough mix. This mixture can be further dried by heating/vacuum or other dehydration methods to reduce the water content to 39%. This drier mixture has unique advantages when molded in an injection system. This mixture is stable and can be molded hot or stored by refrigeration, but not frozen.

### Example LL

### 100% Waxy Potato Starch

1. Form a pre-gelled cellulose paper-waxy potato starch suspension:

5.8 g waxy potato starch: 8.3%

6.5 g virgin cellulose pulp: 9.2%

58 g water: 82.5%

To Rapid Gel the pre-gelled cellulose-potato starch (part 1), mix fiber into preheated water at 70-85 deg C. and mix with a paddle blade in a KITCHEN AID® Commercial Mixer. When the fiber is well dispersed, the starch is Rapid Gelled by additional mixing until the temperature drops below 62 deg C. This may take 30 or more minutes to complete. At this time, the mixture is a homogeneous pre-gel suspension. Once gelled, the gel may be used hot, cooled or refrigerated, but not frozen.
2. Premix the following materials to form a homogenous dry mixture:

32.2 g waxy potato starch

0.25 g magnesium stearate

0.05 g foaming agent
3. Slowly add the Part 2 homogenous dry mixture to the pre-gelled fiber-starch using low speed on the KITCHEN AID® Commercial Mixer until blended and for ten additional min. to condition the dough mix. This mixture is stable and can be molded hot or stored by refrigeration, but not frozen.

### Example MM

### Potato Starch Wood Fiber Formula

1. Form a pre-gelled potato starch wood fiber suspension:

58 g waxy potato starch

65 g virgin cellulose pulp

580 g water

To Rapid Gel the pre-gelled cellulose-potato starch (part 1), mix fiber into preheated water at 70-85 deg C. and mix with a paddle blade in a KITCHEN AID® Commercial Mixer. When the fiber is well dispersed, the starch is Rapid Gelled by additional mixing until the temperature drops below 62 deg C. This may take 30 or more minutes to complete. At this time, the mixture is a homogeneous pre-gel suspension. Once gelled, the gel may be used hot, cooled or refrigerated (but not frozen) until used.
2. Part 2, premix the following dry materials to form a homogenous mixture:

163 g waxy potato starch

159 g corn starch

26 g wood flour #4025

0.5 g magnesium stearate

0.05 g foaming agent
3. Slowly add the Part 2 homogenous dry mixture to the pre-gelled fiber-starch using low speed on the KITCHEN AID® Commercial Mixer until blended and for ten additional min. to condition the dough mix. This mixture is stable and can be molded hot or stored by refrigeration, but not frozen.

### Example MM-1

### Pre-Gelatinized Potato Starch Cellulose/Wood Fiber Formula

1. Part 1, form a suspension using pre-gelatinized potato starch and cellulose/wood fiber:

8.7 g pre-gelatinized potato starch

9.75 g virgin wood fiber or cellulose fiber

87 g water

Mix the pre-gelatinized potato starch with the water (temperature between 22 and 25 deg C.), using low speed on the KITCHEN AID® Commercial Mixer and stir until the pre-gelatinized potato starch is fully hydrated and the suspension is homogeneous. Now disperse the fiber and mix until homogeneous. This may take 30 or more minutes to complete. Once mixed, the gel may be used as is or refrigerated, but not frozen.
2. Part 2, premix the following dry materials to form a homogenous mixture:

53.1 g native or reclaimed potato starch

0.4 g magnesium stearate

0.07 g foaming agent
3. Slowly add the Part 2 homogenous dry mixture to the pre-gelatinized potato starch fiber suspension, using low speed on the KITCHEN AID® Commercial Mixer, until well blended. This mixture is stable and can be molded or stored by refrigeration, but not frozen.

### Example NN

### Scale-Up for Batch Processing

The scaled-up batch process can be achieved using, for example, the HOBART® 140 quart mixer which can mix up to 300 kg of dough per hour using the Rapid Gel Method.
Tables 4 and 5 list formulations prepared for batch processing using the HOBART® 140 quart mixer.

TABLE 4
first additions (Pre-Gel by Rapid Gel Method).

| Pre-Gel | NN-1 | | NN-2 | | NN-3 | | NN-4 | | NN-5 | |
|---|---|---|---|---|---|---|---|---|---|---|
| potato starch | 55 | kg | 51 | kg | 51 | kg | 51 | kg | 51 | kg |
| cellulose | 5.4 | kg | 6.5 | kg | 6.5 | kg | 6.5 | kg | 6.5 | kg |
| Water | 56 | kg | 56 | kg | 56 | kg | 56 | kg | 56 | kg |

| 72 deg C. | | | | | | | |
|---|---|---|---|---|---|---|---|
| Canola oil | 0 | 475 | g | 475 | g | 0 | 0 |

TABLE 5
second addition (Homogenous Dry Mixture)

| | Homogenous Mix | | | | | | | | | |
|---|---|---|---|---|---|---|---|---|---|---|
| | NN-1 | | NN-2 | | NN-3 | | NN-4 | | NN-5 | |
| native | 163 | kg | 172 | kg | 163 | kg | 0 | | 163 | kg |
| tapioca | | | | | | | | | | |
| modified | 0 | | 50 | kg | 0 | | 56 | kg | 0 | |
| tapioca | | | | | | | | | | |
| native corn | 159 | kg | 0 | | 159 | kg | 169 | kg | 0 | |
| native potato | 0 | | 100 | kg | 0 | | 10 | kg | 0 | |
| diatomaceous | 0 | | 0 | | 0 | | 0 | | 5.5 | kg |
| earth | | | | | | | | | | |
| magnesium | 250 | g | 250 | g | 250 | g | 250 | g | 250 | g |
| stearate | | | | | | | | | | |
| foaming | 50 | g | 50 | g | 50 | g | 50 | g | 50 | g |

| agent | | | | | | | |
|---|---|---|---|---|---|---|---|
| citric acid | 0 | 23 | g | 37 | g | 0 | 0 |

Homogenous moldable compositions were prepared according to the following steps:
1. Form a pre-gelled cellulose fiber potato starch suspension using the Rapid Gel Method. Mix fiber and oil into preheated water, at 72 to 85 deg C. and mix on high speed with a paddle blade. When the fiber is well dispersed, add gelling starch and mix until the temperature drops below 62 deg C. This may take 30 or more minutes to complete. At this time, the mixture is a homogeneous gel suspension. Once gelled, the gel may be used hot, cooled or refrigerated, but not frozen.
2. Slowly add the Table 2 homogenous dry mixture to the pre-gelled fiber-starch, mix on low speed until blended and for up to 30 minutes to assure complete mixing and de-structuring of the starch. For selected products the mixing time can be extended to produce a drier dough. This mixture is stable and can be molded hot or stored by refrigeration, but not frozen.

### Example OO

TABLE 6
Small batch formulas with and without Diatomaceous Earth

| | Example | | | | | |
|---|---|---|---|---|---|---|
| Ingredient | OO-1 | OO-2 | OO-3 | OO-4 | OO-5 | OO-6 |
| Step one: Rapid | g | g | g | g | g | g |
| Gel Method | | | | | | |
| Waxy Potato Starch | 51 | 51 | 58 | 0 | 0 | 0 |
| Native Potato Starch | 0 | 0 | 0 | 54 | 51 | 72.5 |
| Cellulose fiber | 65 | 65 | 65 | 65 | 65 | 82.5 |
| Water at 72 deg C. | 550 | 510 | 560 | 580 | 550 | 450 |
| Soy Oil | 4.75 | 0 | 4.75 | 4.75 | 0 | 0 |
| Step two: blended | g | g | g | g | g | g |
| dry ingredients | | | | | | |
| Native Tapioca | 163 | 163 | 0 | 163 | 105 | 204 |
| starch | | | | | | |
| Modified Tapioca | 0 | 0 | 32³ | 0 | 0 | 0 |
| starch | | | | | | |
| Native corn starch | 0 | 159 | 159 | 0 | 0 | 0 |
| Native potato starch | 0 | 0 | 131 | 0 | 100 | 0 |
| Diatomaceous earth | 55¹ | 0 | 0 | 55⁴ | 40⁴ | 68.5⁴ |
| Magnesium Stearate | 2.5 | 2.5 | 2.5 | 3.75 | 2.5 | 1.25 |
| Foaming agent² | 0.5 | 0.05 | 0.5 | 0.5 | 0.5 | 0 |
| Citric Acid | 0.37 | 0 | 0.37 | 0.37 | 0 | 0 |
| Xanthan Gum | 0 | 0 | 0 | 0 | 10 | 0 |

¹ = CELITE ® 545 (World Minerals);
² = CT 1480 (Clariant ® Corp);
³ = P450 cross-linked Tapioca Starch (Mulit-Kem Ridgefield, NJ).
⁴DICALITE ® Speedex (Dicalite ® Corp).

### Example PP

### Continuous Mixing Formulas with Diatomaceous Earth Using the Twin Screw 2″ Continuous Processor (Readco Kurimoto®, LLC)

The process is set up in two stages using two Twin Screw 2″×17″ Continuous Processors (Readco Kurimoto®, LLC) working in tandem.
Stage one—Pre-gel of starch and fiber with water occurs in the first processor. In this first embodiment the fiber is metered into the first port of the pre heated Twin Screw 2″×17″ Continuous Processor (Readco Kurimoto®, LLC). Heated [74 deg C.] distilled water is injected into first mixing compartment after the fiber port followed by the addition of the gelling starch [reclaimed native potato] into the second port. The series of twenty-five paired mixing elements [paddles] in the first stage produced a continuous stream of gelled starch-fiber mixture into the first port of the Stage two heated Twin Screw 2″×17″ Continuous Processor (Readco Kurimoto®, LLC) where corn starch [with premixed additives] and diatomaceous earth were added at the second port of the second stage unit. The second stage unit also utilized a series of twenty-five paired mixing elements [paddles]. The RPM of the first unit was set at 150 and the second unit set at 200. The production rate of finished product was set at 100 pounds per hour.

TABLE 7
Stage one additions (Pre-Gel by Rapid Gel Method)
using a high shear Twin Screw
2″ × 17″ Continuous Processor (Readco Kurimoto ®, LLC).

| Addition | PP-1 | PP-2 | PP-3 | PP-4 | PP-5 |
|---|---|---|---|---|---|
| potato | 0.180 | 0.153 | 0.142 | 0.175 | 0.190 |
| starch | #/min | #/min | #/min | #/min | #/min |
| fiber | 0.183 | 0.173 | 0.158 | 0.198 | 0.213 |
| | #/min | #/min | #/min | #/min | #/min |
| Water | 0.678 | 0.742 | 0.822 | 0.607 | 0.523 |
| 55 deg C. | #/min | #/min | #/min | #/min | #/min |

TABLE 8
Stage two addition using a Twin Screw 2″ × 17″
Continuous Processor (Readco
Kurimoto ®, LLC).

| Addition | PP-1 | PP-2 | PP-3 | PP-4 | PP-5 |
|---|---|---|---|---|---|
| corn starch* | 0.483 | 0.453 | 0.413 | 0.518 | 0.560 |
| | #/min | #/min | #/min | #/min | #/min |
| diatomaceous | 0.155 | 0.145 | 0.133 | 0.168 | 0.180 |
| earth | #/min | #/min | #/min | #/min | #/min |
| production | 100 | 100 | 100 | 100 | 100 |
| rate | #/hour | #/hour | #/hour | #/hour | #/hour |

*additives such as magnesium or calcium stearate, colorants and foaming agents can be pre-mixed in the corn starch to reduce the number of ports needed to add all of the required ingredients.

We claim:

1. A process to produce a biofoam composition comprising:
i) rapidly pre-gelling a starch mixture;
ii) adding a diatomaceous earth (DE) mixture to form a combined mixture;
iii) mixing until the combined mixture is a homogeneous moldable mixture; and
iv) molding the homogeneous moldable mixture into a biofoam composition.

2. The process of claim 1, wherein the DE mixture comprises a native DE.

3. The process of claim 1, wherein the DE mixture comprises a processed DE.

4. The process of claim 2, wherein the native DE is either from fresh water or salt water.

5. The process of claim 4, wherein the native DE is from fresh water.

6. The process of claim 3, wherein the processed DE is flux calcined DE.

7. The process of claim 1, wherein the DE comprises 1-35% by weight of the biofoam composition.

8. The process of claim 1, wherein molding is selected from the group consisting of: injection molding, compression molding, or extrusion molding.

9. The process of claim 1, wherein molding is injection molding.

10. The process of claim 1, wherein the combined mixture comprises one or more of the group consisting of: native starches, reclaimed starches, waxy starches, modified starches, and pre-gelatinized starches.

11. The process of claim 10, wherein the combined mixture comprises one or more of the group consisting of: fiber, powder, pulp, foaming agents, mold release agents, bentonite clay, and thickening agents.

12. The process of claim 11, wherein the combined mixture comprises one or more of the group consisting of: phospholipids, oils, citric acid, colorants, and titanium dioxide.

13. The process of claim 1, wherein the starch mixture comprises fiber.

14. The process of claim 13, wherein the combined mixture comprises one or more of the group consisting of: native starches, reclaimed starches, waxy starches, modified starches, and pre-gelatinized starches.

15. The process of claim 14, wherein the combined mixture comprises one or more of the group consisting of: powder, pulp, foaming agents, mold release agents, bentonite clay, and thickening agents.

16. The process of claim 15, wherein the combined mixture comprises one or more of the group consisting of: phospholipids, oils, citric acid, colorants, and titanium dioxide.

17. The process of claim 13, wherein the DE mixture comprises starch.

18. The process of claim 18, wherein the molding is injection molding.

19. The process of claim 13, wherein the fiber comprises virgin or recycled fiber.

20. The process of claim 1, wherein the biofoam composition is in the form of a cup, tray, bowl, plate, utensil, coffee cup, or microwave dinner tray.
